(19) United States
(12) Patent Application Publication
(10) Pub. No.: US 2018/0234036 A1
(43) Pub. Date: Aug. 16, 2018

(54) Programmable Driver For Single Phase Brushless DC (BLDC) Motor With Hall Sensor

(71) Applicant: Microchip Technology Incorporated, Chandler, AZ (US)

(72) Inventors: Mark Pallones, Quezon City (PH); Mike Gomez, Makati City (PH); Joseph Julicher, Maricopa, AZ (US)

(73) Assignee: Microchip Technology Incorporated, Chandler, AZ (US)

(21) Appl. No.: 15/885,994

(22) Filed: Feb. 1, 2018

Related U.S. Application Data
(60) Provisional application No. 62/457,247, filed on Feb. 10, 2017.

(51) Int. Cl. H02P 6/06; H02P 6/17; H02P 6/26

(52) U.S. Cl. CPC H02P 6/06; H02P 6/26; H02P 6/17

(57) ABSTRACT

A BLDC motor drive system may be configured to provide a programmable PWM current waveform, e.g., a sinusoidal PWM current, to the motor. The drive system may include control electronics configured to generate a series of PWM control signals at a control signal frequency based on (a) the present motor speed data as determined by an angular timer, based on sensor-based rotor angle data, (b) a target motor speed, e.g., based on a thermal management unit, and (c) stored current waveform data defining a target current for each angular segment of the BDLC rotor, the target currents defining an non-rectangular waveform shape. The PWM control signals are used by a PWM unit to produce a non-rectangular, e.g., sinusoidal, PWM current for controlling the BDLC.

### CROSS-REFERENCE To RELATED APPLICATIONS

This application claims priority to commonly owned U.S. Provisional Patent Application No. 62/457,247 filed Feb. 10, 2017, which is hereby incorporated by reference herein for all purposes.

### TECHNICAL FIELD

The present disclosure relates electric motors and, more particularly, to a programmable driver, e.g., having a sinusoidal waveform, for single phase brushless direct current (BLDC) motor with a hall sensor.

### BACKGROUND

Direct current (DC) motors utilize commutation to convert electrical current into a rotational torque of a rotor. Commutation is the act of changing the motor phase currents at the appropriate times to produce rotational torque. In a brushed DC motor, the motor assembly contains a physical commutator which is moved by means of actual brushes in order to move the rotor. In a brushless DC motor (BLDC), electrical current powers a permanent magnet that causes the motor to move, so no physical commutator is necessary.

More particularly, a BLDC motor accomplishes commutation electronically using rotor position feedback to determine when to switch the current between different stator coils of the motor, to cooperate with permanent magnets on the rotor to generate a rotational torque in the rotor. A Hall sensor or a rotary encoder is typically used to provide feedback regarding the rotational position of the rotor.

BDLCs are typically used for low power, low torque applications, e.g., for computer fans or other low power fan applications. Existing driver solutions may drive a BLDC motor by a rectangular current which produces torque ripple during commutation. Pulsating torque ripple may cause unwanted mechanical vibration and noise.

### SUMMARY

Embodiments of the present disclosure provide a programmable driver for a single phase brushless direct current (BLDC) motor with a hall sensor, and a BLDC controlled by such driver. In some embodiments, the programmable driver may drive the BLDC using a sinusoidal current. Thus, rather than rectangular current drive produced by existing single phase BLDCM drivers, embodiments of the present disclosure drive the motor with sinusoidal or other programmable current drive with a configurable interface and without complex computation. The use of the sinusoidal or other programmable current may reduce or eliminate the generation of pulsation torque in the motor, and thus reduce or eliminate unwanted mechanical vibration and noise.

One embodiment provides a system for driving a brushless direct current (BLDC) motor with a programmable current waveform. The system may include an angular timer, a target motor speed control unit, current waveform data, current waveform data, PWM control electronics, and a PWM unit. The angular timer may be configured to receive rotor position data indicating an angular position of a rotor of the BLDC, and determine present motor speed data associated with a present speed of the rotor based on the received rotor position data. The target motor speed control unit may be configured to generate target motor speed data indicating a target motor speed. The current waveform data (e.g., stored in memory, or accessible by function calls in firmware) may define a target current for each of a series of angular segments in a rotation of the BLDC rotor, the target current for the series of angular segments defining a current waveform having a non-rectangular shape. The PWM control electronics may be configured to generate a series of pulse width modulation (PWM) control signals at a control signal frequency based on: the present motor speed data determined by the angular timer, the target motor speed data generated by the target motor speed control unit. and the current waveform data defining the shape of the target current waveform. The series of PWM control signals generated by the PWM control electronics may correspond with the series of angular segments in the rotation of the BLDC rotor, wherein each PWM control signal indicates a target current for a respective angular segment. The PWM unit may be configured to receive the series of PWM control signals from the PWM control electronics at the control signal frequency and produce a PWM current for controlling the BDLC. For each respective PWM control signal received by the PWM unit, wherein the respective PWM control signal indicates a target current magnitude for a respective angular segment, the PWM unit may be configured to dynamically control at least one pulse characteristic to produce a PWM segment current corresponding with the target current for the respective angular segment indicated by the respective PWM control signal. The PWM segment current for at least one angular segment may include PWM pulsing at a higher frequency than the control signal frequency.

In one embodiment, the BLDC is a single-phase BLDC. In another embodiment, the BLDC is a two-phase BLDC.

In one embodiment, the current waveform memory stores current waveform data defining a target current waveform having a sinusoidal shape.

In one embodiment, the current waveform data stored in the current waveform memory comprises a lookup table defining a target current for each of the series of angular segments within the rotation of the BLDC rotor.

In one embodiment, the angular timer is configured to output a series of angular segment signal pulses at an angular timer frequency corresponding with the present motor speed data determined by the angular timer based on the received rotor position data, each angular segment signal pulse corresponding with an angular segment within the rotation of the BLDC rotor. Further, the PWM control electronics may be configured to, for each angular segment signal pulse output by the angular timer: identify from the current waveform data a target current for the respective angular segment; adjust target current for the respective angular segment based on the target motor speed data generated by the target motor speed control unit; and communicate the adjusted target current for the respective angular segment to the PWM unit. The PWM unit may be configured to: receive the adjusted target current for each respective angular segment; and dynamically control at least one pulse characteristic to produce a PWM segment current corresponding with the adjusted target current for each respective angular segment.

In one embodiment, the angular timer configured to determine present motor speed data associated with a present speed of the rotor based on the received rotor position data comprises the angular timer configured to determine a duration of a prior rotation of the BLDC rotor based on the received rotor position data.

In one embodiment, the target motor speed control unit is configured to generate target motor speed data based on temperature data detected by a temperature sensor.

In one embodiment, the target motor speed control unit is configured to receive signals from a thermal management chip on a printed circuit board, and generate target motor speed data based on the received signals from the thermal management chip.

Another embodiment includes a system including a brushless direct current (BLDC) motor; and a motor drive system for driving the BDLC with a programmable current waveform. The motor drive system may include an angular timer, a target motor speed control unit, current waveform data, current waveform data, PWM control electronics, and a PWM unit. The angular timer may be configured to receive rotor position data indicating an angular position of a rotor of the BLDC, and determine present motor speed data associated with a present speed of the rotor based on the received rotor position data. The target motor speed control unit may be configured to generate target motor speed data indicating a target motor speed. The current waveform data (e.g., stored in memory, or accessible by function calls in firmware) may define a target current for each of a series of angular segments in a rotation of the BLDC rotor, the target current for the series of angular segments defining a current waveform having a non-rectangular shape. The PWM control electronics may be configured to generate a series of pulse width modulation (PWM) control signals at a control signal frequency based on: the present motor speed data determined by the angular timer, the target motor speed data generated by the target motor speed control unit. and the current waveform data defining the shape of the target current waveform. The series of PWM control signals generated by the PWM control electronics may correspond with the series of angular segments in the rotation of the BLDC rotor, wherein each PWM control signal indicates a target current for a respective angular segment. The PWM unit may be configured to receive the series of PWM control signals from the PWM control electronics at the control signal frequency and produce a PWM current for controlling the BDLC. For each respective PWM control signal received by the PWM unit, wherein the respective PWM control signal indicates a target current magnitude for a respective angular segment, the PWM unit may be configured to dynamically control at least one pulse characteristic to produce a PWM segment current corresponding with the target current for the respective angular segment indicated by the respective PWM control signal. The PWM segment current for at least one angular segment may include PWM pulsing at a higher frequency than the control signal frequency.

### BRIEF DESCRIPTION OF THE FIGURES

Example aspects and embodiments are discussed below with reference to the drawings, in which:

FIG. 1 shows a BLDC system including a BDLC and a programmable driver system configured to drive the BLDC using a sinusoidal or other programmable current, according to embodiments of the present invention;

FIG. 2 shows an example sinusoidal waveform divided into angular segments, which may be used for a waveform look-up table used by a programmable driver system of FIG. 1 or FIG. 2 for providing a sinusoidal current to the BDLC, according to an example embodiment;

FIG. 3 shows an example PWM signal generated by a PWM unit of the programmable driver system of FIG. 1 or FIG. 2 for producing sinusoidal currents delivered to the BDLC windings, according to an example embodiment; and

FIG. 4 shows an example programmable driver system for driving a BLDC using a sinusoidal or other programmable current, according to an example embodiment

### DETAILED DESCRIPTION

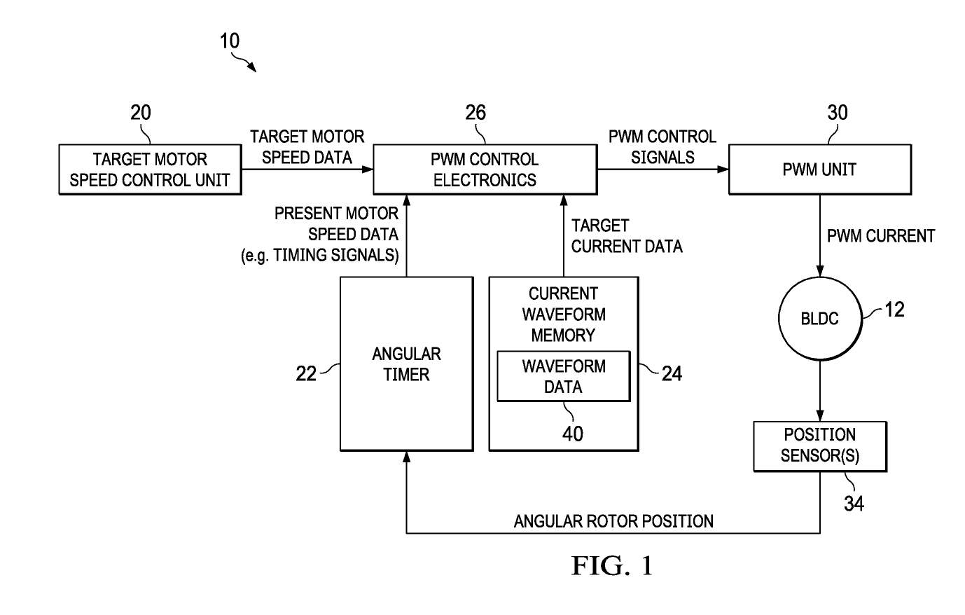

FIG. 1 illustrates a motor drive system 10 for driving a brushless direct current (BLDC) motor 12 with a programmable current waveform, e.g., a sinusoidal current, according to example embodiments. As shown, motor drive system 10 may include a target motor speed control unit 20, an angular timer 22, a current waveform memory 24 storing current waveform data 40 defining a current waveform (e.g., a sinusoidal waveform), PWM control electronics 26, and a PWM unit 30.

BLDC motor 12 may be a single-phase or two-phase motor, for example. Further, BLDC motor 12 may including any suitable number of poles, e.g., rotor poles and stator slots. For example, in one embodiment, BLDC motor 12 includes a four-slot stator and a four-pole permanent rotor.

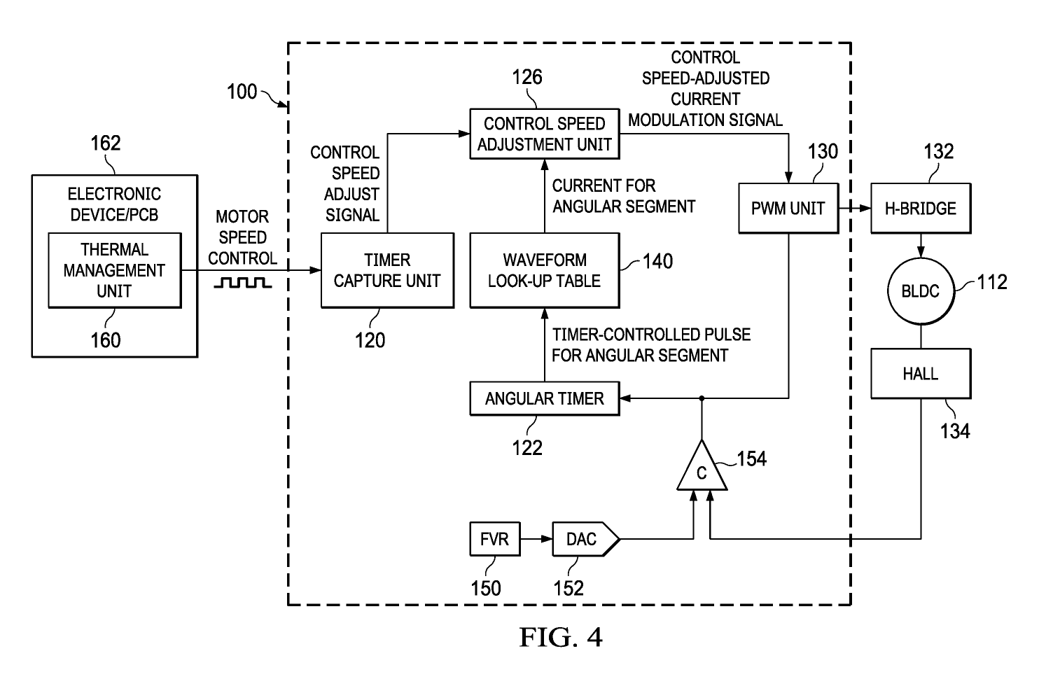

Target motor speed control unit 20 may be configured to generate target motor speed data indicating a target motor speed for BLDC motor 12. For example, where BLDC motor 12 drives a cooling fan, the target motor speed may be based on thermal management data of a microprocessor, a printed circuit board (PCB), or other electronic components or devices, e.g., based on signals generated by one or more temperature sensors. As discussed below with reference to the example embodiment shown in FIG. 4, target motor speed control unit 20 may include a timer capture unit that receives target motor speed signals from a thermal management chip on a PCB, and processes the target motor speed signals to output a control speed adjustment signal to PWM control electronics 26.

Angular timer 22 may be configured to monitor the present speed of the BDLC motor 12 (e.g., the rotor speed) and control the timing or frequency of PWM control signals generated by PWM control electronics based on the present speed of BDLC motor 12. Angular timer 22 may monitor the present speed of the BDLC motor 12 based on signals generated by one or more rotor position sensors associated with BDLC motor 12, e.g., one or more Hall sensors configured to detect the angular position of the BLDC rotor. In some embodiments, determining the present motor speed may consist of determining a duration of a defined angular rotation (e.g., one full rotation) of the BLDC rotor based on the received position data from the rotor position sensor(s) 34. For example, angular timer 22 may determine the present motor speed based on the duration of the most recent full rotation of the rotor, based on data from position sensor(s) 34. In other embodiments, angular timer 22 may additionally or alternatively calculate an angular speed of the rotor.

Angular timer 22 may output a series of timing signals at a timing/frequency corresponding to the determined present motor speed of BLDC 12. In some embodiments, motor drive system 10 may subdivide each full rotation (360 degrees) of the BLDC rotor into a defined set of angular segments, e.g., 360 1-degree angular segments, 120 3-degree angular segments, 36 10-degree angular segments, or any other defined set of angular segments. The examples discussed below use an example division of the rotor position into a sequence of 36 10-degree angular segments. Thus, according to such example, angular timer 22 may determine the duration (period) of the most recent full rotation (Rotation i) of the rotor, indicated as period T_{full}_{_}ᵣₒₜₐₜᵢₒₙ_{_}ᵢ and output a series of 36 timing signals at a frequency of 36/Tᵣₒₜₒᵣ_{_}_{360°}_{_}ᵣₒₜₐₜᵢₒₙ, i.e., one timing signal every 1/36*T_{full}_{_}ᵣₒₜₐₜᵢₒₙ_{_}ᵢ, which timing signals may be used (by PWM control electronics 26) as input for controlling the next rotation (Rotation i+1) of the BLDC rotor. Angular timer 22 may then determine the duration (period) of the this next rotation, T_{full}_{_}ᵣₒₜₐₜᵢₒₙ_{_}ᵢ₊₁, and output a new series of 36 timing signals at a timing/frequency corresponding to the determined T_{full}_{_}ᵣₒₜₐₜᵢₒₙ_{_}ᵢ₊₁. As discussed below, for each timing signal output by angular timer 22, corresponding current waveform data 40 may be identified and utilized by PWM control electronics 26 to control PWM unit 30 for the angular segment (e.g., 10-degree angular segment) corresponding to that respective timing signal. Each series of 36 timing signals and corresponding current waveform data 40 advances through one pass of a defined current waveform (e.g., sinusoidal curve) defined by the current waveform data 40.

Angular timer 22 may also control the reset timing of each subsequent rotation. For example, each time angular timing 22 detects a predefined position of the rotor (e.g., 0°), angular timing 22 may communicate a waveform reset signal (e.g., via a marker in selected timing signals) to reset the system to deliver the current waveform data 40 for the initial angular segment (e.g., corresponding to angular segment 0°-10°), to thereby keep the system synchronized.

As noted above, current waveform memory 24 may store current waveform data 40 defining a current waveform for driving BLDC 12, e.g., a sinusoidal waveform or other non-rectangular waveform. In some embodiments, current waveform data 40 may define a target current for defined angular segment, and wherein the target currents collectively define a current waveform, e.g., a sinusoidal waveform. For example, using the example of 36 10-degree segments, the current waveform data 40 may comprise a lookup table defining a target current for each of the 36 angular segments.

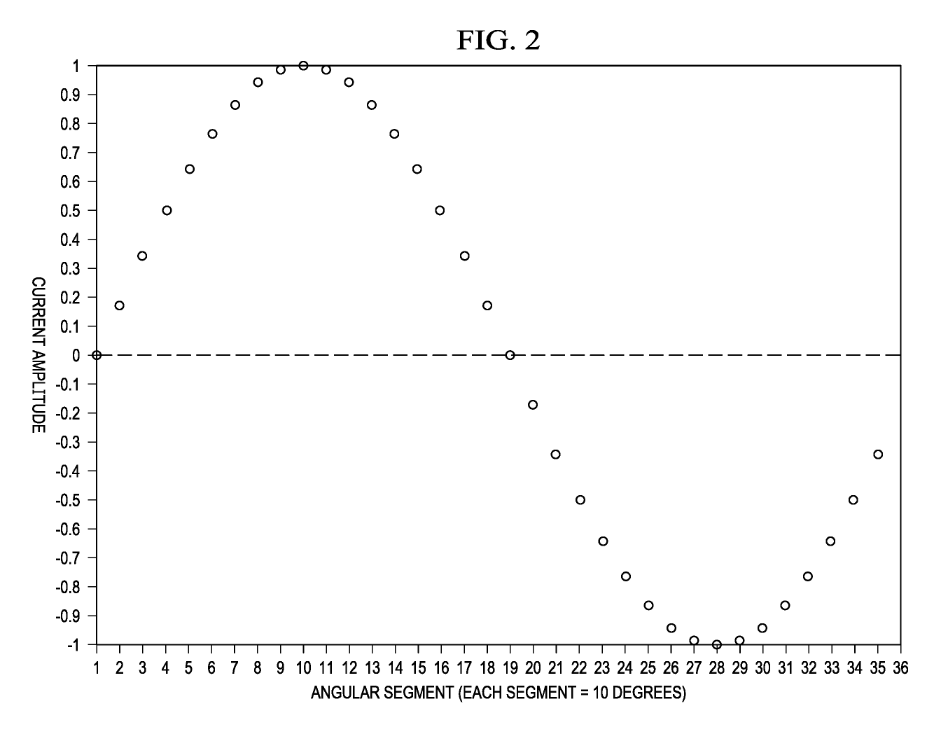

FIG. 2 illustrates a graph of an example set of target currents for 36 angular segments, which may be stored as a lookup table, according to an example embodiment. As shown, the example target current data shown in FIG. 2 defines a sinusoidal waveform. The value of each target current data point may represent a percentage of a predefined maximum current, or may alternatively indicate an actual current value.

As discussed above, each timing signal output by angular timer 22 may trigger the system to lookup the target current value of the angular segment corresponding to the respective timing signal, and communicate this target current value to PWM control electronics 26.

PWM control electronics 26 are configured to generate a series of pulse width modulation (PWM) control signals for PWM unit 30 at a control signal frequency (corresponding to the timing signal frequency set by angular timer 22) based on (a) the angular segment timing signals output by angular timer 22 based on the determined present motor speed, (b) the control speed adjustment signals output by target motor speed control unit 20 (e.g., based on target motor speed signals from a thermal management unit/chip), and (c) the current waveform data 40 communicated in connection with each respective angular segment timing signal output by angular timer 22. The series of PWM control signals generated by PWM control electronics 26 correspond with the series of angular segments, such that PWM control electronics 26 generates PWM control signals for each angular segment that indicate a target current for that respective angular segment.

In one embodiment, for each angular segment timing signals output by angular timer 22, PWM control electronics 26 may (a) identify from the stored current waveform data 40 a target current for the respective angular segment of the timing signal, (b) adjust the target current for the respective angular segment based on the control speed adjustment signals received from target motor speed control unit 20, and communicate the adjusted target current for the respective angular segment to the PWM unit 30.

PWM unit 30 is configured to receive PWM control signals, including an adjusted target current for each respective angular segment, from PWM control electronics 26 at the control signal frequency and produce a PWM current for controlling BDLC 12. For example, for each respective PWM control signal (including an adjusted target current for the respective angular segment) received at PWM unit 30, PWM unit 30 may dynamically control at least one pulse characteristic (e.g., pulse amplitude, frequency, duty cycle, pulse width, period, etc.) to produce a PWM current for the respective angular segment that corresponds with the adjusted target current for that angular segment as indicated by the respective PWM control signal received from PWM control electronics 26. PWM unit 30 may include or control any suitable electronics to produce the PWM current applied to BLDC 12 for each angular segment, e.g., one or more FETs, switches, H-bridge, and/or any other electronic components or circuitry connected with a suitable voltage supply/current source.

In some embodiments, to produce the PWM current for each angular segment, PWM unit 30 may switch the current on and off to create any number of PWM pulses within the duration of the angular segment, e.g., 0 pulses, 1 pulse, or any number of multiple pulses, e.g., bounded by a maximum number of pulses defined by a maximum pulsing frequency of the PWM unit 30.

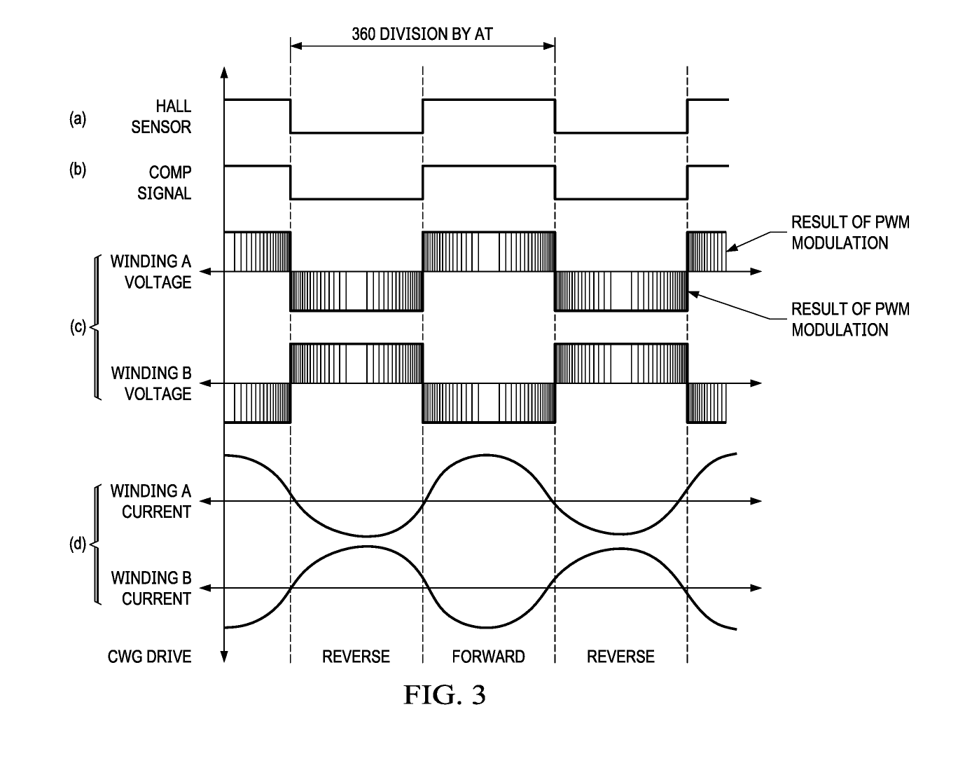

FIG. 3 illustrates an example PWM signal generated by PWM unit 30 to deliver a sinusoidal current to the windings of BLDC 12, according to an example embodiment. FIG. 3 illustrates (a) a signal generated by a Hall sensor detecting the rotor position of BLDC 12, as a function of time, (b) a comparator signal output by a comparator arranged to compare the Hall sensor signal to a reference signal (discussed below with reference to the embodiment of FIG. 4), (c) a PWM voltage signal produced by PWM unit 30 (by controlling relevant electronics, e.g., switches, etc.) for a pair of motor windings A and B, as function of time; and (d) the resulting PWM sinusoidal current applied to each motor winding A and B.

Each 360° angular period (corresponding with one full rotation of the rotor) is divided into 36 10-degree angular segments, with the period of each angular segment defined by the timing signals output by angular timer 22. Thus, the width of each angular segment, and thus the resulting width of each 360° angular period, shown in FIG. 3 is controlled by angular timer 22. Further, as discussed above, each 10-degree angular segment may include zero, one, or multiple PWM pulses, as defined by PWM unit 30 to provide the adjusted target current for the respective angular segment (based on the PWM control signals for the respective angular segment received from PWM control electronics 26). As shown, as the rotor position advances from each angular segment to the next angular segment, PWM unit 30 may dynamically adjust at least one pulse characteristic (e.g., pulse amplitude, frequency, duty cycle, pulse width, period, etc.) to produce a PWM current that matches the adjusted target current for the respective angular segment

FIG. 4 shows an example programmable motor driver system 100 for driving a BLDC 112 using a current having a sinusoidal or other programmable waveform, according to one example embodiment. Motor driver system 100 includes a timer capture unit 120, an angular timer 122, a waveform lookup table 140, a speed adjustment unit 126, a PWM unit 130, a fixed voltage reference (FVR) 150, a digital-to-analog converter (DAC) 152, and comparator 154. In one embodiment, driver system 100 may be implemented using a collection of core independent peripherals. BLDC motor 112 may be a single phase or two-phase BLDC motor, for example.

Timer capture unit 120 may be configured to determine a target motor speed based on signals received from a thermal management unit 160 associated with an electronic device or PCB 162, for example. Thermal management unit 160 may output a motor speed control signal in the form of a low frequency pulsed signal having a duty cycle corresponding to a target motor speed. Timer capture unit 120 may comprise a signal measurement timer configured to measure the duty cycle of the motor speed control signal output by the thermal management unit 160 and generate and output a corresponding speed control signal to control speed adjustment unit 126.

Angular timer (AT) 122 may be configured to determine the position of the BLDC rotor. For example, a Hall sensor 134 may be configured to detect the angular position of the BDLC rotor and output position signals to comparator 154, which may compare the Hall sensor signals to a reference voltage, e.g., output by fixed voltage reference (FVR) 150 and processed by digital-to-analog converter (DAC) 152, as shown in FIG. 4. Comparator 154 may be configured to output signals indicating specific positions of the rotor, e.g., each 0° position of the rotor, or each 0° and 180° rotor position, or each 0°, 90°, 180°, and 270° rotor position, for example.

Angular timer 122 may determine the time period for completing the most recent full rotation of the rotor based on signals from comparator 154, e.g., by measuring the time between the most recent pair of 0° rotor position signals from comparator 154. As discussed above regarding angular timer 22 shown in FIG. 1, angular timer 122 may output a series of timing signals at a timing/frequency based on (a) a defined number of angular segments within each 360° rotation (e.g., 36 10-degree segments as discussed above) and (b) the determined present motor speed of BLDC 112 (e.g., the measured time period of most recent rotation of the rotor). For example, angular timer 22 may output a timing signal at a frequency of 1/36 of the most recent time period measured for the full rotor rotation, for a total of 36 timing signals corresponding to the 36 angular segments (in this example) in the next rotor rotation. The timing signal may also identify the number of the angular segment.

Each timing signal output by angular timer 22 triggers the lookup and forwarding (to control speed adjustment unit 126) of a target angular segment current specified by waveform lookup table 140 for the angular segment identified by or corresponding to the respective timing signal from angular timer 22. Waveform lookup table 140 may be stored in memory or embodied by function calls in firmware, for example.

Control speed adjustment unit 126 may be configured to adjust each target angular segment current received from waveform lookup table 140 based on speed control signals received from timer capture unit 120 (e.g., based on signals from a thermal management chip, as discussed above). For example, speed control signals may indicate a percentage (e.g., a value between 0 and 1) of a maximum target motor speed. Control speed adjustment unit 126 may include suitable circuits for multiplying or performing other arithmetic (e.g., a MathACC “math accelerator” core independent peripheral by Microchip Technology Inc.) that multiplies each target angular segment current received from waveform lookup table 140 by the current percentage value indicated by the speed control signals being received by timer capture unit 120. Control speed adjustment unit 126 may output the resulting adjusted target angular segment current for each sequential angular segment to PWM unit 30, which may then control a current delivered to BLDC 112 for each sequential angular segment based on the adjusted target angular segment current for each respective angular segment, e.g., by controlling the PWM duty cycle for each respective angular segment current.

Thus, one embodiment may operate as follows. During start up, comparator 154 may detect the state of the Hall sensor 134. When the Hall sensor signal is high, comparator 154 forces a complementary waveform generator (CWG) in PWM unit 130 to operate in full bridge forward mode. When the hall sensor signal is low, comparator 154 forces the CWG in PWM unit 130 to operate in full bridge reverse mode. This may ensure that correct switching of MOSFETs in the H-Bridge 132 based on the rotational position of the BLDC rotor. When the motor 112 spins, angular timer 122 detects the rising edge of the Hall sensor via comparator 154 to mark the 0° phase of the rotor (or other predefined rotor position). Then, angular timer 122 may continuously detect the angular degree position of the rotor based on signals from comparator 154 based on the Hall sensor signal. Angular timer 122 determines the rotor speed (e.g., time between consecutive 0° positions of the rotor) and outputs a clock-based timer signal for each angular segment to lookup a corresponding target speed value, e.g., a duty cycle value, stored a waveform (e.g., sinusoidal) look-up table 140 for each respective angular segment.

For each angular segment, the target speed value, e.g., duty cycle value, is forwarded to control speed adjustment unit 126 (e.g., Microchip's MATHACC peripheral), which multiplies the duty cycle value by a motor speed adjustment value received from timer capture unit 120 (e.g., based on a duty cycle of a signal output by a thermal management chip associated with a PCB, electronic device, etc.) The waveform look-up table 140 may be implemented in memory or may be accessible through function calls in firmware. The output of control speed adjustment unit 126 is used by PWM unit 130 to produce a sinusoidal PWM (SPWM), which is fed into a CWG of PWM unit 130 for driving an H-Bridge circuit 132 to apply the current to drive the motor 112 with a sinusoidal current. The Full bridge mode of the CWG may also be based on detected phase angle of the angular timer 122, as discussed above. For example, when the measured rotor phase angle is between 0 and 180 degrees, the mode is set to forward, and when the detected rotor phase angle is between 180 and 360 degrees, the CWG mode is set to reverse. This allows a change of commutation of the rotor and thus the continuous rotation of the motor.

Each component of system motor drive systems 10 and 100 shown in FIGS. 1 and 4 may be embodied in hardware, software, or firmware, and may be implemented using digital circuitry, analog circuitry, or a suitable combination thereof. Further, the functionality of each component or unit disclosed above may be implemented by instructions in a non-transitory computer-readable medium which, when loaded and executed by a processor, causes the processor to perform the operations and functionality described in the present disclosure.

Embodiments of the present invention may address problems with at least some conventional systems and methods. Some embodiments provide a single phase or two-phase Brushless DC motor and a motor drive system that drives the BLDC using a sinusoidal or other non-rectangular current waveform. The motor may be used for applications such as a low power fan applications, for example. Existing driver solutions may drive the motor by rectangular current which produces torque ripple during commutation. Pulsating torque ripple may be the main source mechanical vibration and noise. Rather than rectangular current drive produced by existing single phase BLDCM drivers, embodiments of the present disclosure drive the motor with sinusoidal or other non-rectangular current drive with a configurable interface and without complex computation. The sinusoidal or other non-rectangular current waveform may reduce or eliminate the generation of pulsation torque.

1. A system for driving a brushless direct current (BLDC) motor with a programmable current waveform, the system comprising:
an angular timer configured to:
receive rotor position data indicating an angular position of a rotor of the BLDC;
determine present motor speed data associated with a present speed of the rotor based on the received rotor position data;
a target motor speed control unit configured to generate target motor speed data indicating a target motor speed;
current waveform data defining a target current for each of a series of angular segments in a rotation of the BLDC rotor, the target current for the series of angular segments defining a current waveform having a non-rectangular shape;
PWM control electronics configured to generate a series of pulse width modulation (PWM) control signals at a control signal frequency based on:
the present motor speed data determined by the angular timer;
the target motor speed data generated by the target motor speed control unit; and
the current waveform data defining the shape of the target current waveform;
wherein the series of PWM control signals generated by the PWM control electronics correspond with the series of angular segments in the rotation of the BLDC rotor, wherein each PWM control signal indicates a target current for a respective angular segment; and
a PWM unit configured to receive the series of PWM control signals from the PWM control electronics at the control signal frequency and produce a PWM current for controlling the BDLC;
wherein for each respective PWM control signal received by the PWM unit, the respective PWM control signal indicating a target current magnitude for a respective angular segment, the PWM unit is configured to dynamically control at least one pulse characteristic to produce a PWM segment current corresponding with the target current for the respective angular segment indicated by the respective PWM control signal;
wherein the PWM segment current for at least one angular segment includes PWM pulsing at a higher frequency than the control signal frequency.

2. The system of claim 1, wherein the BLDC is a single-phase BLDC.

3. The system of claim 1, wherein the BLDC is a two-phase BLDC.

4. The system of claim 1, wherein the current waveform data defining a target current waveform having a sinusoidal shape.

5. The system of claim 1, wherein the current waveform data comprises a lookup table defining a target current for each of the series of angular segments within the rotation of the BLDC rotor.

6. The system of claim 1, wherein:
the angular timer is configured to output a series of angular segment signal pulses at an angular timer frequency corresponding with the present motor speed data determined by the angular timer based on the received rotor position data, each angular segment signal pulse corresponding with an angular segment within the rotation of the BLDC rotor;
the PWM control electronics are configured to, for each angular segment signal pulse output by the angular timer:
identify from the current waveform data a target current for the respective angular segment;
adjust target current for the respective angular segment based on the target motor speed data generated by the target motor speed control unit; and
communicate the adjusted target current for the respective angular segment to the PWM unit;
wherein the PWM unit is configured to:
receive the adjusted target current for each respective angular segment; and
dynamically control at least one pulse characteristic to produce a PWM segment current corresponding with the adjusted target current for each respective angular segment.

7. The system of claim 1, wherein the angular timer configured to determine present motor speed data associated with a present speed of the rotor based on the received rotor position data comprises the angular timer configured to determine a duration of a prior rotation of the BLDC rotor based on the received rotor position data.

8. The system of claim 1, wherein the target motor speed control unit is configured to generate target motor speed data based on temperature data detected by a temperature sensor.

9. The system of claim 1, wherein the target motor speed control unit is configured to receive signals from a thermal management chip on a printed circuit board, and generate target motor speed data based on the received signals from the thermal management chip.

10. A system, comprising:
a brushless direct current (BLDC) motor; and
a motor drive system for driving the BDLC with a programmable current waveform, the motor drive system comprising:
an angular timer configured to:
receive rotor position data indicating an angular position of a rotor of the BLDC;
determine present motor speed data associated with a present speed of the rotor based on the received rotor position data;
a target motor speed control unit configured to generate target motor speed data indicating a target motor speed;
current waveform data defining a target current for each of a series of angular segments in a rotation of the BLDC rotor, the target current for the series of angular segments defining a current waveform having a non-rectangular shape;
PWM control electronics configured to generate a series of pulse width modulation (PWM) control signals at a control signal frequency based on:
the present motor speed data determined by the angular timer;
the target motor speed data generated by the target motor speed control unit; and
the current waveform data defining the shape of the target current waveform;
wherein the series of PWM control signals generated by the PWM control electronics correspond with the series of angular segments in the rotation of the BLDC rotor, wherein each PWM control signal indicates a target current for a respective angular segment; and
a PWM unit configured to receive the series of PWM control signals from the PWM control electronics at the control signal frequency and produce a PWM current for controlling the BDLC;
wherein for each respective PWM control signal received by the PWM unit, the respective PWM control signal indicating a target current magnitude for a respective angular segment, the PWM unit is configured to dynamically control at least one pulse characteristic to produce a PWM segment current corresponding with the target current for the respective angular segment indicated by the respective PWM control signal;
wherein the PWM segment current for at least one angular segment includes PWM pulsing at a higher frequency than the control signal frequency.
